(19) United States
(12) Patent Application Publication
(10) Pub. No.: US 2012/0304522 A1
(43) Pub. Date: Dec. 6, 2012

(54) POLE FOR USE TO PULL IN A JUG OR NOODLE WHILE FISHING

(76) Inventor: Larry Kenneth Baxley, Midland City, AL (US)

(21) Appl. No.: 13/477,014

(22) Filed: May 21, 2012

Related U.S. Application Data
(60) Provisional application No. 61/493,781, filed on Jun. 6, 2011.

(51) Int. Cl. A01K 99/00; A01K 97/14

(52) U.S. Cl. 43/4.5; 43/5

(57) ABSTRACT

A pole with a device on one end thereof is adapted to hook or grab a line that is attached to a jug or noodle to allow the user to pull in the jug or noodle without having to lean over the side of a boat and physically grab the jug or noodle from the water. The pole of the present invention will allow all anglers, including the young, elderly and others, to enjoy the fun, action and excitement of jug fishing without the fear of losing one's balance when retrieving the jug or noodle.

### CROSS-REFERENCE TO RELATED APPLICATIONS

This application claims the benefit of priority of U.S. provisional patent application No. 61/493,781, filed Jun. 6, 2011, the contents of which are herein incorporated by reference.

### BACKGROUND OF THE INVENTION

The present invention relates to fishing poles and, more particularly, to a pole with a device to pull in a jug or noodle while fishing.

Jug (or noodle) fishing is a tackle-free method of fishing that uses lines suspended from floating jugs to catch fish in lakes or rivers. Often, several jugs are used when jug fishing. Jug fishing uses a relatively simple setup where lines are tied onto jugs and weights can be added to the line to keep the jug's location fixed.

When a fish hits the hook, action can be seen in the floating jug. The angler has to then take their boat over to the jug (or noodle) and lean over the side of the boat to grab the jug or noodle with their hands. This could be dangerous and inconvenient, especially for the young, elderly and others.

As can be seen, there is a need for a pole to allow anglers to safely and easily retrieve their jug or noodle while fishing.

### SUMMARY OF THE INVENTION

In one aspect of the present invention, a pole for jug or noodle fishing comprises at least one pole section; and a hook disposed on one end of the pole section, wherein the hook curves to extend along the pole section at an angle from about 160 degrees to about 180 degrees, wherein a distal end of the hook curves away from the pole section.

In another aspect of the present invention, a method for fishing with a float comprises disposing the float in water, the float having a line with a hook attached thereto; monitoring the float for signs of a fish on the hook; extending a hook on a pole under the float to catch the line in the hook; and pulling the pole tip out of the water to lift the float out of the water and toward a user.

These and other features, aspects and advantages of the present invention will become better understood with reference to the following drawings, description and claims.

### BRIEF DESCRIPTION OF THE DRAWINGS

FIG. 1 is a perspective drawing showing a jug (or noodle) fishing pole, in use, according to an exemplary embodiment of the present invention;

FIG. 2 is a perspective view of the jug fishing pole of FIG. 1; and

FIG. 3 is a cross-sectional view taken along line 3-3 of FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a pole with a device on one end thereof adapted to hook or grab a line that is attached to a jug or noodle to allow the user to pull in the jug or noodle without having to lean over the side of a boat and physically grab the jug or noodle from the water. The pole of the present invention will allow all anglers, including the young, elderly and others, to enjoy the fun and excitement of jug fishing without the fear of losing one's balance when retrieving the jug or noodle.

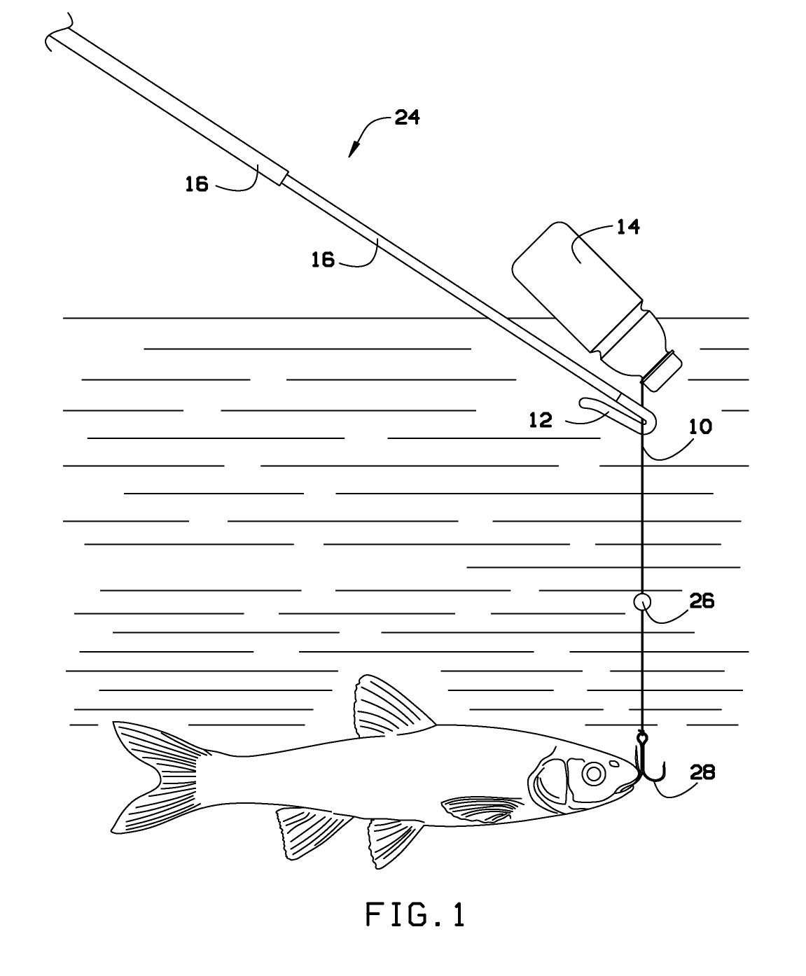

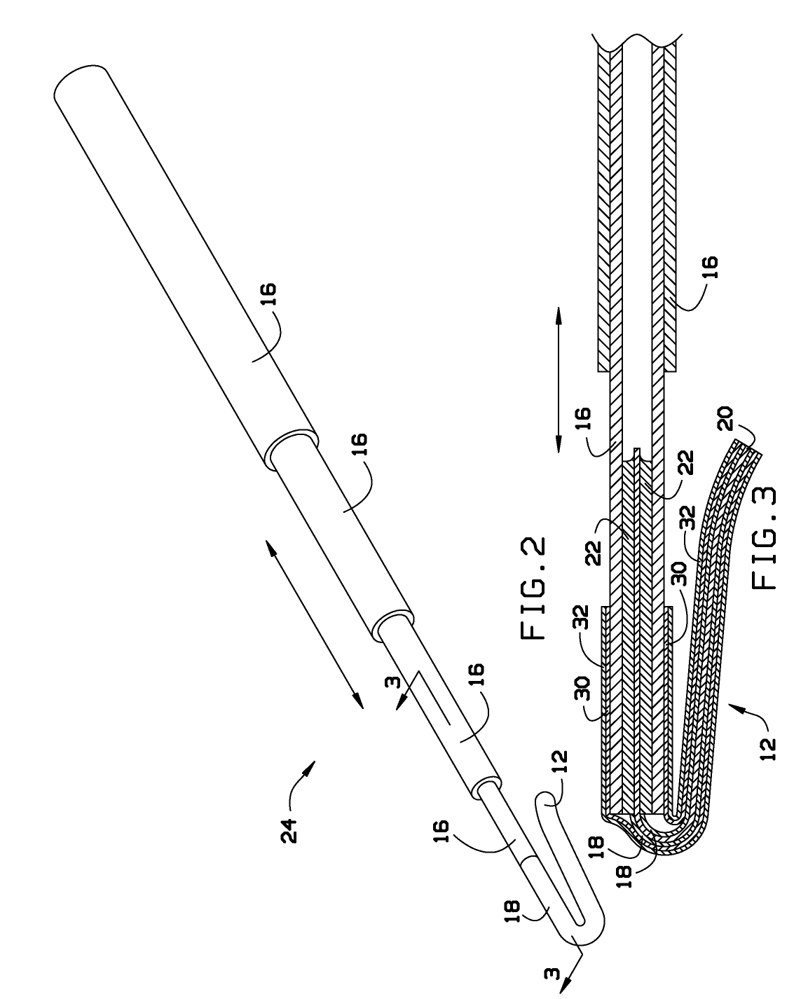

Referring now to FIGS. 1 through 3, a pole 24 may include one or more sections of tubing 16 with a hook 12 on one end thereof. The hook 12 may be adapted to hook about a fishing line 10 attached to a jug 14 to pull the jug 14 to an angler while jug or noodle fishing. The fishing line may include a sinker 26 and a fish hook 28, as is conventional in the jug fishing art. It should be noted that the term jug or jug fishing is used herein, but the pole 24 of the present invention can be used for retrieving noodles while “noodle fishing” in a similar manner, where the noodles replace the jugs as a float.

In some embodiments, the pole 24 may be made of multiple sections of tubing 16 that can fit inside each other and can telescope to change the overall length of the pole 24. The pole 24 may be made of fiberglass, graphite or some other desired material and may include from one to about sixteen telescoping sections to provide a pole that is from about 2 to about 16 feet long. The pole 24 can be made from light to heavy action. The pole 24 can include a handle (not shown), such as a foam handle, for user comfort.

The hook 12 may be disposed on the end of the pole 24. The hook 12 may vary in size, length and shape, provided that is can grab/hook the line of the jug or noodle. The hook 12 can be attached to the pole 24 in various ways or can be molded into the pole 24 during manufacture. The material of the hook 12 can be the same or different from that of the pole 24, and may vary in size, length and degree of bend. In some embodiments, the hook 12 may curve about an angle of from about 160 to about 180 degrees and may curve outward, away from the pole 24 on a distal end thereof. This outward curving provides the user with a larger diameter line capturing area, where, when the user moves the hook underwater beyond the fishing line and pulls the hook towards them, the line can be easily caught by the line capturing area and be fed into the bend in the hook.

While there are various manners to connect the hook 12 to the pole 24, one exemplary embodiment is shown in FIG. 3. A wire 20 may be inserted inside the pole section 16 and secured with glue 22. The wire 20 may form a hook 12 by curving back along the pole section 16. The wire 20 may be covered with a heat shrink tubing 18, and/or covered with a bright, reflective or glow material 30 (which itself can be heat shrink material) and which can sealed with a transparent heat shrink tubing 32. The reflective or glow material 30 may be optional and may be excluded in some embodiments of the present invention. In some embodiments, the wire 20 may be about 2 mm in diameter and about 150 mm long, with about 70 mm inserted into the pole section 16 and about 80 mm extending out from the pole section 16. Of course, other methods, sizes and shapes of the hook 12 may be contemplated within the scope of the present invention.

The pole can be used not only when bringing in a float that has a fish on its hook, but may also be used to retrieve a float. The hook can grab the line and the float, without a fish on the hook, would be heavier than any sinker/weight on the line and, therefore, the line will lift out of the water until the hook catches the sinker and allows the user to lift the float out of the water. The pole may be useful to retrieve floats that are in otherwise irretrievable locations (and, as such, are sometimes just left there by the angler) such as near shore, under brush, or the like.

The pole of the present invention may be various types of poles, including a telescoping pole, as described above. In other embodiments, the pole may be a standard fishing pole, rod and reel combination, a bream buster, a crappie pole, or the like.

It should be understood, of course, that the foregoing relates to exemplary embodiments of the invention and that modifications may be made without departing from the spirit and scope of the invention as set forth in the following claims.

What is claimed is:

1. A pole for jug or noodle fishing, the pole comprising:
at least one pole section; and
a hook disposed on the end of the pole section, wherein the hook curves to extend along the pole section at an angle from about 160 degrees to about 180 degrees, wherein a distal end of the hook curves away from the pole section.

2. The pole for jug or noodle fishing of claim 1, wherein the at least one pole section includes a plurality of telescoping pole (1 to 16) sections.

3. The pole for jug or noodle fishing of claim 1, wherein the pole is from about 2 to about 16 feet long.

4. The pole for jug or noodle fishing of claim 1, further comprising bright (yellow) material covering the tip of the pole and hook.

5. A method for fishing with a float, comprising:
disposing the float in water, the float having a line with a hook attached thereto;
monitoring the float for signs of a fish on the hook;
extending a hook on a pole under the float to catch the line in the hook; and
pulling the pole tip out of the water to lift the float out of the water and toward a user.

6. The method of claim 5, wherein the float is a jug or noodle.

7. The method of claim 5, wherein the hook curves back against the pole at an angle from about 160 to about 180 degrees.

8. The method of claim 5, wherein the hook has a distal end that curves away from the pole to provide a wider line capturing area.

9. The method of claim 5, further comprising telescoping the pole to a desired length.

10. The method of claim 5, further comprising lifting the float with the hook and netting the fish which allows the float to release from the hook.
